(19) United States
(12) Patent Application Publication
(10) Pub. No.: US 2011/0247455 A1
(43) Pub. Date: Oct. 13, 2011

(54) CRANK ARM PROTECTOR

(76) Inventor: Robert Densmore, Rimrock, AZ (US)

(21) Appl. No.: 13/012,923

(22) Filed: Jan. 25, 2011

Related U.S. Application Data
(60) Provisional application No. 61/323,606, filed on Apr. 13, 2010.

(51) Int. Cl. B62M 3/16

(52) U.S. Cl. 74/612

(57) ABSTRACT

A protector for the crank arm of a bicycle fits over the outer end of the crank arm to protect the arm from damage and marring during bicycle use over rough terrain particularly when the arm hits the ground while pedaling.

### CROSS-REFERENCE TO RELATED APPLICATION

The present application claims the benefit of provisional application Ser. No. 61/323,606, filed Apr. 13, 2010, and the entire content of that application is incorporated herein by reference.

### BACKGROUND OF THE INVENTION

The present invention relates to a protector, and more particularly to protectors for the crank arms of bicycles.

High performance and expensive bicycles are often used off road on rough terrain such as mountain trails and the like. Often, during such use, parts of the bicycle are damaged and/or marred thereby resulting in financial loss. Particularly vulnerable parts of these bicycles are the crank arms, each of which is connected at its inside end to the bicycle sprocket and at its outside end to the bicycle pedals. As the cyclist pedals along through rough terrain, the crank arms often strike the terrain with significant force thereby causing damage and marring of the crank arms particularly at the outside ends thereof next to the pedals.

### SUMMARY OF THE INVENTION

Accordingly, one of the objects of the present invention is a protector for the outer end of the crank arm of a bicycle which functions in a highly efficient manner to protect the arm from damage and severe marring during bicycle use, particularly on rough terrain.

Another object of the present invention is a crank arm protector which is relatively inexpensive, but highly beneficial in protecting the crank arm from the ravages of bicycle use on rough terrain.

In accordance with the present invention, a protector for the outer end of the crank arm of a bicycle comprises a U-shaped upstanding side wall having inside and outside peripheral portions. An arch-shaped front wall is connected to the outside peripheral portion of the U-shaped side wall, and an opening in the front wall is constructed and arranged to receive a foot pedal axle after the protector is in place on the outer end of the crank arm and before the pedal is secured to the arm.

The crank arm protector may be fabricated of thermoplastic material, and the protector basically fits over the outer free end of the bicycle crank arm in order to protect the arm from hitting the ground on rough terrain while pedaling the bicycle. The protector is held onto the crank arm by the treaded axle of the pedal secured to the crank arm.

### BRIEF DESCRIPTION OF THE DRAWINGS

Novel features and advantages of the present invention in addition to those mentioned above will become apparent to persons of ordinary skill in the art from a reading of the following detailed description in conjunction with the accompanying drawings wherein similar reference characters refer to similar parts and in which:

FIG. 1 is a perspective view of a crank arm protector, according to the present invention;

FIG. 2 is a front elevational view of the crank arm protector of FIG. 1;

FIG. 3 is a rear elevational view of the crank arm protector of FIG. 1;

FIG. 4 is a bottom plan view of the crank arm protector of FIG. 1;

FIG. 5 is a top plan view of the crank arm protector of FIG. 1;

FIG. 6 is a perspective view of the crank arm protector of FIG. 1 mounted onto a bicycle pedal axle before releasable pedal securement to the crank arm;

FIG. 7 is a another perspective view of the crank arm protector of FIG. 1 mounted onto a bicycle pedal before pedal securement to the crank arm; and

FIG. 8 is a side elevational view of the crank arm with the protector in place prior to releasable pedal securement to the crank arm.

### DETAILED DESCRIPTION OF THE INVENTION

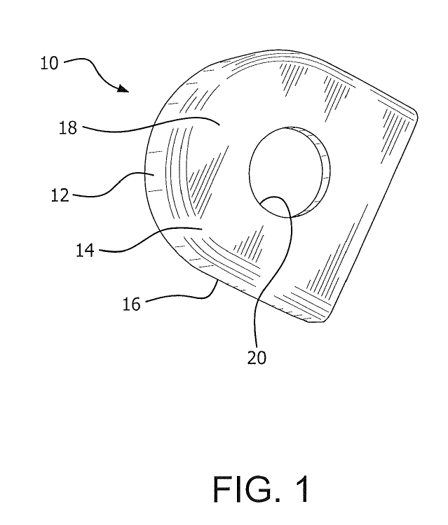

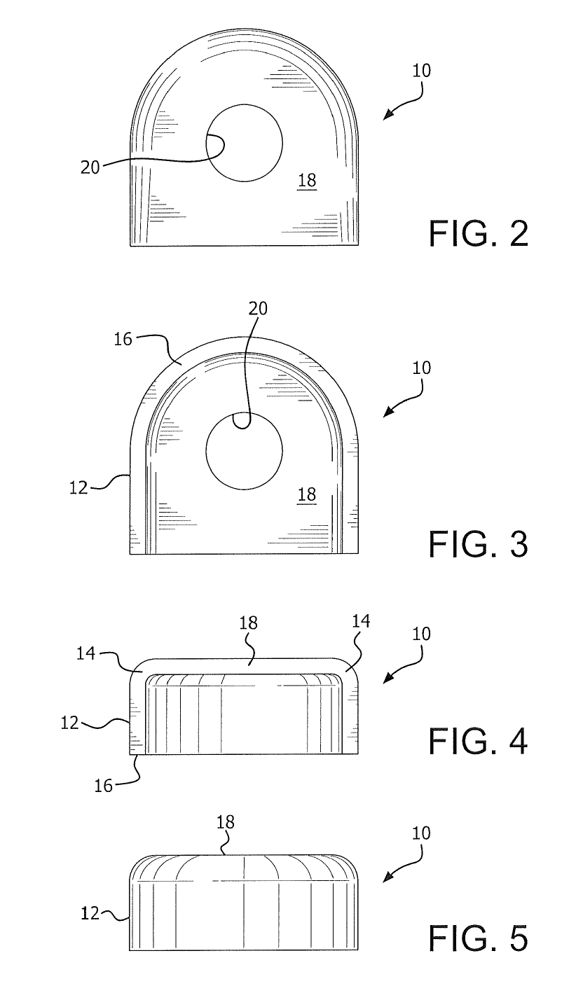

Referring in more particularity to the drawings, FIGS. 1-6 illustrate a protector 10 constructed and arranged to fit over the outer end of the crank arm of a bicycle. The protector may be fabricated from thermoplastic material as well as other materials that may be desired. Fundamentally, the protector includes a U-shaped sidewall 12 having outside and inside peripheral portions 14 and 16, respectively. A flat arch-shaped front wall 18 is connected to the outside peripheral portion 14 of the sidewall 12. An opening 20 in the front wall 18 is constructed and arranged to receive a foot pedal axle after the protector 10 is in place on the outer end of the crank arm and before the pedal is releasably secured to the arm, as described more fully below.

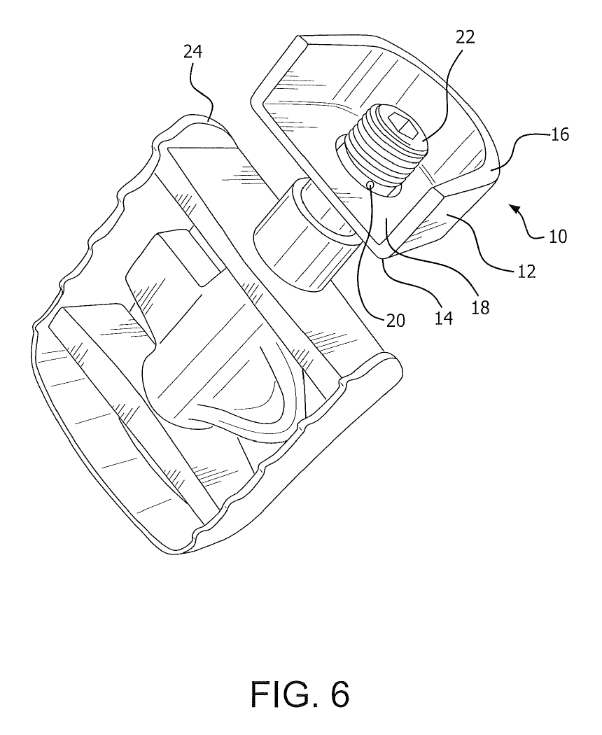

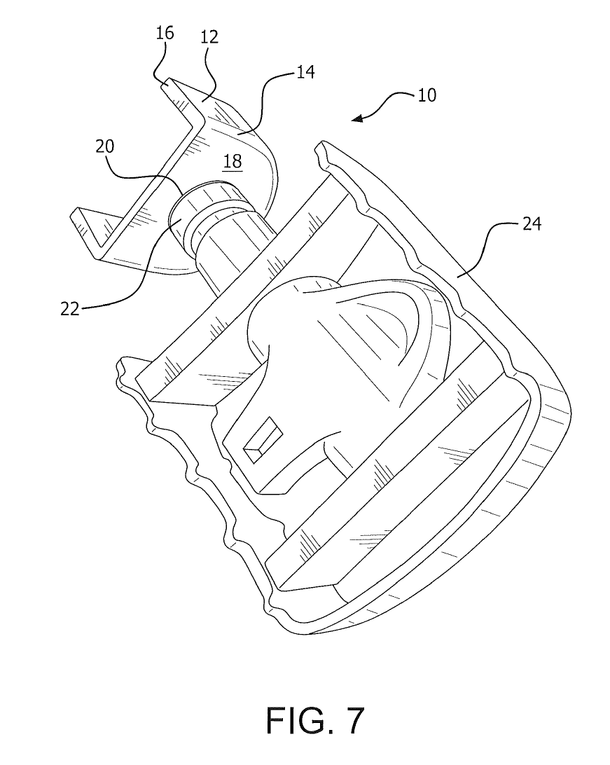

Referring to FIGS. 6 and 7, the protector 10 is initially positioned over the axle 22 of a bicycle pedal 24. The axle is initially inserted into the opening 20 of the protector with the arch-shaped front wall 18 closest to the pedal, as shown these Figures.

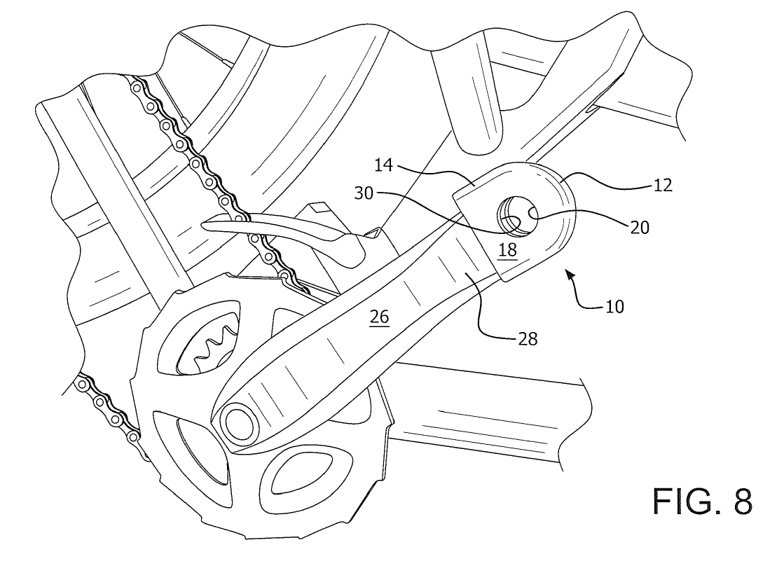

FIG. 8 shows an actual crank arm 26 with the protector 10 fitted over the outer end 28 of the arm and prior to releasable threaded securement of the pedal axle 22 to the crank arm 26. After such assembly of the protector 10 over the outer end of the crank arm, the pedal is secured to the arm by threaded insertion of the axle 22 into the pedal receiving opening 30 in the crank arm.

During use of the bicycle with protectors 10 in place on the outer ends 28 of the crank arms 26, the protectors function to protect the crank arm from directly hitting the ground particularly when pedaling on rough terrains.

Additionally, the opening 20 in the front wall 18 of the protectors 10 may include a metal bushing to maintain the structural integrity of the protector when the axle 22 of the bicycle pedal 24 is screw threaded into the threaded opening 30 of the crank arm. Alternatively, or in addition, washers may be placed on opposing sides of the front wall 18 of the protector with the axle 22 of the pedal extending through the washers as the axle 22 is screw threaded into the opening 30.

We claim:

1. A protector for the outer end of a crank arm of a bicycle comprising a U-shaped upstanding sidewall having outside and inside peripheral portions, an arch-shaped front wall connected to the outside peripheral portion of the sidewall, and an opening in the front wall constructed and arranged to receive a foot pedal axle after the protector is in place on the outer end of the crank arm and before the pedal is secured to the arm.

2. A protector as in claim 1 in combination with a bicycle crank arm having an outer end with a foot pedal releasably secured thereto, and wherein the protector is positioned over the outer end of the crank arm between the arm and foot pedal.

3. A protector as in claim 1 wherein the protector comprise a unitary piece fabricated of thermoplastic material.
